(19) United States
(12) Patent Application Publication
(10) Pub. No.: US 2014/0379369 A1
(43) Pub. Date: Dec. 25, 2014

(54) Patient Identification and Monitoring System

(71) Applicants: Georgios Kokovidis, Waltham, MA (US); Randolph Prydekker, Wilmot, NH (US); William Dowd, Dracut, MA (US)

(72) Inventors: Georgios Kokovidis, Waltham, MA (US); Randolph Prydekker, Wilmot, NH (US); William Dowd, Dracut, MA (US)

(73) Assignee: Draeger Medical Systems, Inc., Andover, MA (US)

(21) Appl. No.: 14/370,205

(22) PCT Filed: Jan. 4, 2012
(86) PCT No.: PCT/US2012/020233

§ 371 Date: Jul. 1, 2014

(51) Int. Cl. G06F 19/00

(52) U.S. Cl. CPC G06F 19/3418
USPC 705/2

(57) ABSTRACT

In one aspect, disclosed is a system including a first data acquisition device configured to be coupled to the patient to acquire clinical data and a patient-assigned monitor coupled to the first data acquisition device that includes a first wireless communication module and a monitor identification code. The system also includes an ambulatory patient device having an identification code reader configured to capture the monitor identification code, a second data acquisition device configured to acquire clinical data from the patient and a second wireless communication module. Capture of the monitor identification code by the identification code reader automatically initiates wireless pairing between the patient-assigned monitor and the ambulatory patient device. Related apparatus, systems, methods and/or articles are described.

### TECHNICAL FIELD

The subject matter described herein relates generally to the field of medical devices, and more particularly to devices, systems, articles, and methods in the pairing of various data acquiring devices with each other and with a particular patient.

### BACKGROUND

Clinicians frequently need to monitor various physiological parameters to assess and monitor the health of a patient, such as heart rate, blood oxygen saturation, blood pressure, respiration rate, body temperature, electrocardiogram (ECG), and any other clinical data that may be required depending on the patient's condition and the care being provided. The various physiological parameters can be collected by a variety of sensors and devices that then transmit the data to a patient monitor. The type of patient monitor used depends on the severity and urgency (termed acuity) of the medical condition of the patient. Occasionally a patient may be connected to more than one monitor at the same time. For example, a patient may be connected to a limited parameter monitor while the clinician needs to periodically observe a few physiological parameters. In other cases, the patient acuity level may suddenly change, forcing the immediate connection of the patient to a higher complexity monitor monitoring many physiological parameters.

Often the physiological data is transmitted to the patient monitor in a wireless manner. However, the patient may be in the vicinity of another patient similarly monitored by one or more devices that also transmit acquired patient data in a wireless manner to that patient's monitoring station. Further, some physiological parameters are measured on a periodic basis, such as a nurse traveling from patient to patient to obtain non-invasive blood pressure (NIBP) measurements. Each of these scenarios presents the risk that the patient data may “bind” to the wrong patient monitor. A problem also exists in associating the data acquired from a patient using one device with the patient's data record stored on another device.

### SUMMARY

Described herein are systems and devices that pair a patient and the patient's clinical data collected at the point of care by a bedside patient monitor with another device not already associated with that patient.

In one aspect, disclosed is a system including a first data acquisition device configured to be coupled to the patient to acquire clinical data. The system also includes a patient-assigned monitor coupled to the first data acquisition device that includes a first wireless communication module and a monitor identification code. The system also includes an ambulatory patient device having an identification code reader configured to capture the monitor identification code, a second data acquisition device configured to acquire clinical data from the patient and a second wireless communication module. Capture of the monitor identification code by the identification code reader automatically initiates wireless pairing between the patient-assigned monitor and the ambulatory patient device.

The clinical data acquired from the second data acquisition device can be tagged with patient-specific information by the patient-assigned monitor. The patient-specific information can include one or more of a patient hospital identification number, patient name, patient date of birth, patient bed number, and patient room. The clinical data acquired from the second data acquisition device can be wirelessly transmitted from the ambulatory patient device to the patient-assigned monitor. The wirelessly transmitted clinical data can be merged with a medical record for the patient stored in the patient-assigned monitor. The clinical data acquired from the second data acquisition device can be wirelessly transmitted from the ambulatory patient device to a central patient monitor. The wirelessly transmitted clinical data can be merged with a medical record for the patient stored in the central patient monitor.

The system can further include a patient identification code configured to be coupled to a patient. At least one of the patient identification code and the monitor identification code can be a quick response (QR) code. At least one of the patient identification code and the monitor identification code can include encoded patient-specific information. The patient-assigned monitor can further include an identification code reader configured to capture the patient identification code. The monitor identification code can be positioned on an exterior portion of the patient-assigned monitor. The patient-assigned monitor can further include a graphical user interface and the monitor identification code can be displayed on the graphical user interface. The identification code reader can include a CMOS image sensor or CCD image sensor. The first data acquisition device can include at least one of a heart rate monitor, a pulse oximetry sensor, a sphygmomanometer, a thermometer, and electrocardiology equipment. The second data acquisition device can include at least one of a heart rate monitor, a pulse oximetry sensor, a sphygmomanometer, a thermometer, and electrocardiology equipment. The second data acquisition device can be different from the first data acquisition device. Each of the wireless communication modules can be a Bluetooth communication device.

In another interrelated aspect, disclosed is a method including acquiring clinical data using a first data acquisition device coupled to a patient and communicating the clinical data to a patient-assigned monitor. The patient-assigned monitor includes a monitor identification code and a wireless communication module. The method further includes reading the monitor identification code with an identification code reader of an ambulatory patient device. The ambulatory patient device includes a wireless communication module and a second data acquisition device. The method also includes automatically initiating wireless pairing between the wireless communication module of the patient-assigned monitor with the wireless communication module of the ambulatory patient device. The method also includes acquiring clinical data from the patient using the second data acquisition device of the ambulatory patient device. The method also includes wirelessly transmitting the clinical data acquired from the patient using the second data acquisition device.

The method can include tagging the acquired clinical data with patient-specific information with the patient-assigned monitor. The patient-specific information can include one or more of a patient hospital identification number, patient name, patient date of birth, patient bed number, and patient room. Wirelessly transmitting can include wirelessly transmitting the clinical data acquired from the patient using the second data acquisition device from the ambulatory patient device to the patient-assigned monitor. The wirelessly transmitted clinical data can be merged with a medical record for the patient stored in the patient-assigned monitor. Wirelessly transmitting can include wirelessly transmitting the clinical data acquired from the patient using the second data acquisition device from the ambulatory patient device to a central patient monitor. Wirelessly transmitted clinical data can be merged with a medical record for the patient stored in the central patient monitor.

Reading the monitor identification code with an identification code reader of an ambulatory patient device can include capturing a quick response (QR) code on the patient-assigned monitor using an image sensor in the ambulatory patient device. The image sensor can include a CMOS or CCD image sensor. The monitor identification code can include encoded monitor-specific information. The monitor identification code can be positioned on an exterior portion of the patient-assigned monitor. The patient-assigned monitor can further include a graphical user interface and the monitor identification code can be displayed on the graphical user interface. Acquiring clinical data using the first data acquisition device can include acquiring clinical data using at least one of a heart rate monitor, a pulse oximetry sensor, a sphygmomanometer, a thermometer, and electrocardiology equipment. Acquiring clinical data using the second data acquisition device can include using at least one of a heart rate monitor, a pulse oximetry sensor, a sphygmomanometer, a thermometer, and electrocardiology equipment. The second data acquisition device can be different from the first data acquisition device. Each of the wireless communication modules can include a Bluetooth communication device. The method can further include reading a patient identification code on the patient using the identification code reader of the ambulatory patient device.

Articles of manufacture are also described that comprise computer executable instructions permanently stored on non-transitory computer readable media, which, when executed by a computer, causes the computer to perform operations herein. Similarly, computer systems are also described that may include a processor and a memory coupled to the processor. The memory may temporarily or permanently store (e.g., non-transitorily store, etc.) one or more programs that cause the processor to perform one or more of the operations described herein. In addition, methods described herein can be implemented by one or more data processors either within a single computing system or distributed among two or more computing systems.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a schematic illustration of one implementation of a patient monitoring system;

FIG. 2 is a schematic illustration of one implementation of a patient-assigned monitor;

FIG. 3 is a schematic illustration of one implementation of an ambulatory patient device;

FIG. 4 is a schematic illustration of one implementation of a use of the patient monitoring system;

Like reference symbols in the various drawings indicate like elements.

### DETAILED DESCRIPTION

The patient monitoring system described herein can be used to associate patient identification data with patient physiological data transmitted to one or more bedside patient monitors. The patient monitoring system can provide for the pairing of a patient-assigned monitor with an additional device to which the patient is unknown such that data acquired by the additional device can be tagged with patient-specific information and transmitted to the appropriate and intended location, such as the patient's medical record stored on the patient-assigned monitor or the patient's medical record stored on a central patient monitor. The patient monitoring system can also provide for automatic patient admission to a standard hospital network and/or a central patient monitor such as the Infinity® CentralStation (Dräger Medical GmbH). The patient monitoring systems described herein can allow for the pairing of data acquisition devices and their disparate data streams by tagging the data with patient-specific information creating an identifiable data stream that can be transmitted to an intended location. The patient monitoring systems described herein guarantee that the data flow is originating from a single, known and intended patient and being transmitted to a known and intended location.

It should be appreciated that the patient monitoring systems described herein can be used wherever a patient is being treated or monitored, including a patient's home, in a hospital ward or another heath care facility.

Patient Monitoring System

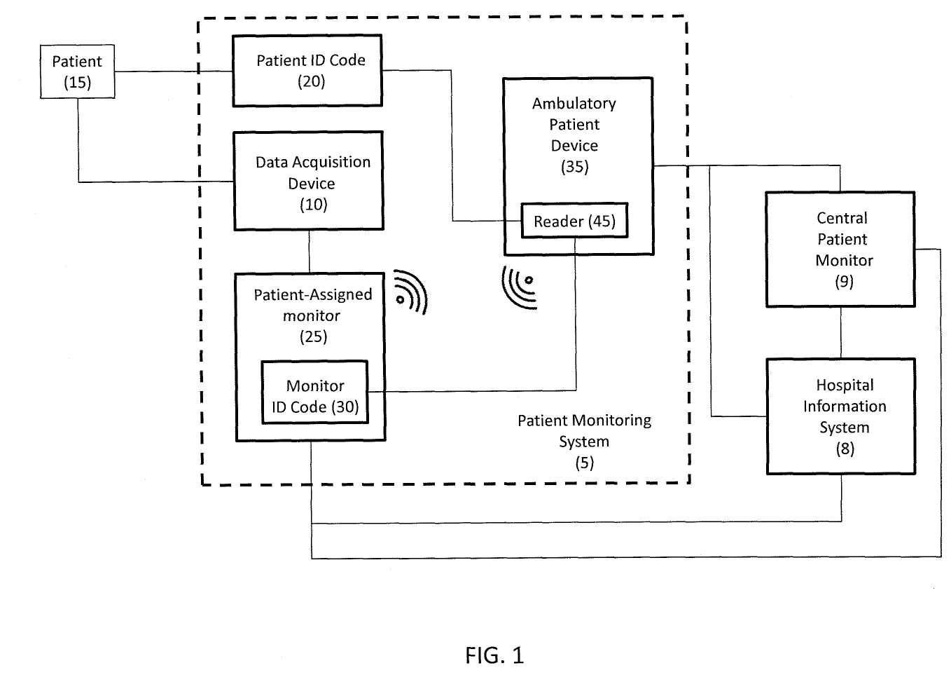

FIG. 1 is a schematic illustration of one implementation of a patient monitoring system 5. The patient monitoring system 5 can include one or more data acquisition devices 10 connected to or associated with a patient 15. The one or more data acquisition devices 10 can be configured to acquire clinical data from the patient 15 and communicate the acquired clinical data to at least one patient-assigned monitor 25. The patient 15 can have a patient identification code 20 and the patient-assigned monitor 25 can have a monitor identification code 30. The identification codes 20, 30 can be QR or “quick response” codes to be described in more detail below. The patient monitoring system 5 can also include at least an ambulatory patient device 35. The ambulatory patient device 35 can be configured to acquire clinical data from a patient 15, for example a physiological parameter that may not already be collected and monitored by the data acquisition device 10 and patient-assigned monitor 25, as will be described in more detail below.

The ambulatory patient device 35 can include an identification code reader 45 configured to capture, scan or otherwise read the identification codes 20, 30. In some implementations, the identification code reader 45 can be an image capture sensor module including for example a CMOS or CCD sensor embedded within the ambulatory patient device 35, as will be described in more detail below. The ambulatory patient device 35 and the patient-assigned monitor 25 can each have wireless capabilities. As will be described in detail below, the identification code reader 45 of the ambulatory patient device 35 can be used to read the identification code 30 of the patient-assigned monitor 25 (as well as the identification code 20 of the patient 15) to automatically initiate wireless pairing between the two and tag the data stream from the ambulatory patient device 35 with patient-specific information prior to transmission of the clinical data from the ambulatory patient device 35. The pairing eliminates the problem of uncertainty regarding from which device or which patient in the vicinity the data is being acquired.

It should be appreciated that one or more components of the patient monitoring system 5 can be in communication via a network of a hospital or other healthcare-providing entity with a hospital information system (HIS) 8. The communication with the network can be wired or wireless, such as via WLAN. One or more components of the patient monitoring system 5 can also be in communication with a central patient monitor 9 as mentioned above.

Data Acquisition Device

The one or more data acquisition devices 10 can be any of a variety of devices configured to acquire clinical data from a patient 15 including, but not limited to, at least one of a heart rate sensor, pulse oximetry sensor for measuring blood oxygen saturation, a manual or automatic sphygmomanometer for measuring blood pressure, continuous invasive blood pressure (CIBP) sensor, noninvasive blood pressure (NIBP) cuff, respiration sensor for measuring respiration rate, thermometer for measuring body temperature, 3-, 5-, 6-, and 12-lead electrocardiogram (ECG), ST segment analysis, full arrhythmia, or other electrocardiology equipment, etCO₂, BISx™, EEG, and any other data acquisition device capable of obtaining clinical data from the patient 15 that may be used depending on the patient's condition and the care being provided.

Patient-Assigned Monitor

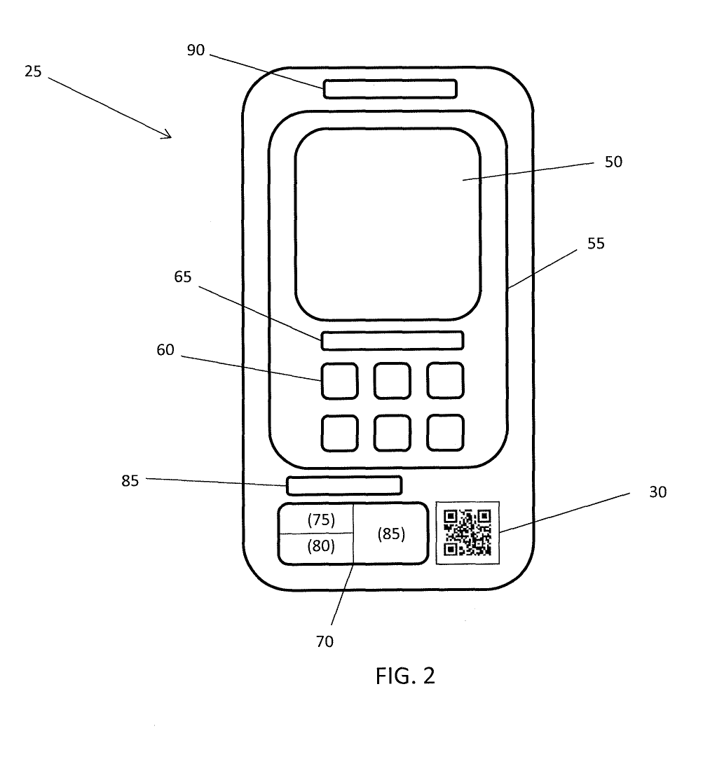

The clinical data obtained from the patient 15 can be transmitted from the one or more data acquisition devices 10 to the patient-assigned monitor 25. As shown in FIG. 2, the patient-assigned monitor 25 can be a high acuity device such as a physiological patient monitor that is a multi-parameter monitor having at least one display 50 including a graphical user interface (GUI) 55 that displays the clinical data and associated patient identifier information acquired from the patient 15. It should be appreciated, however, that the patient-assigned monitor 25 also can be a low acuity device. The patient-assigned monitor 25 can include a stationary, portable or telemetry-enabled patient monitor, including the Infinity® series of patient monitors including Delta, Delta II, Delta XL, M300 telemetry patient worn monitor, or M540 portable patient monitor (Dräger Medical GmbH).

The display 50 can provide information to the user such as patient-specific information including patient identification data (e.g. patient hospital identification number, patient name, patient date of birth, patient bed number, and patient room, etc) as well as clinical data being acquired from the patient by the one or more of the data acquisition devices 10 as well as other patient-specific information. The display 50 can vary including LCD, LED, plasma, OLED, and the like. The display 50 can be interactive or touch-sensitive screen having an input device such as a touch screen, a capacitance screen, a resistive screen or the like. The user interface system 55 can include one or more inputs 60 such as fixed buttons associated with fixed functions or changeable functions such as soft keys associated with the display 50. The soft keys can provide functions wherein the function is displayed and the display 50 can change providing different functions in different situations. The fixed input keys can also have a function that changes depending upon the display provided. The user interface system 55 can also include one or more indicators and/or alarms 65 that may be visual, auditory through a speaker, tactile, and the like.

The patient-assigned monitor 25 can include a control system 70 that can include at least one processor 75, at least one memory 80 coupled to the at least one processor 75 and including at least one program stored thereon. The memory 80 can be any type of memory capable of storing data and communicating that data to one or more other components of the monitor 25, such as the processor 75.

The patient-assigned monitor 25 can include a power system 85. The power system 85 can include a connection to an AC wall power through a power cord. The power system 85 can also include internal battery such as a non-rechargeable or a rechargeable battery. Some embodiments may use a rechargeable battery such as a NiCad battery, LiPo battery, NiMH battery or the like.

The patient-assigned monitor 25 can be configured to communicate with other devices, including the ambulatory patient device 35 or the hospital information system 8, or a central patient monitor 9 through a communication module 90. The communication module 90 can include wired and/or wireless communication capability for the remote sending and receiving of data. The clinical data and patient-specific information may be transmitted from the patient-assigned monitor 25 along a wireless path and/or wired path. Components of the communication module 90 can send and receive commands to the data acquisition device 10 and/or the ambulatory patient device 35. The communication module 90 can include a transmitter and/or receiver, IEEE 802.11 (WiFi) connection, ZigBee, RFID, infrared, Bluetooth communication device or the like.

Ambulatory Patient Device

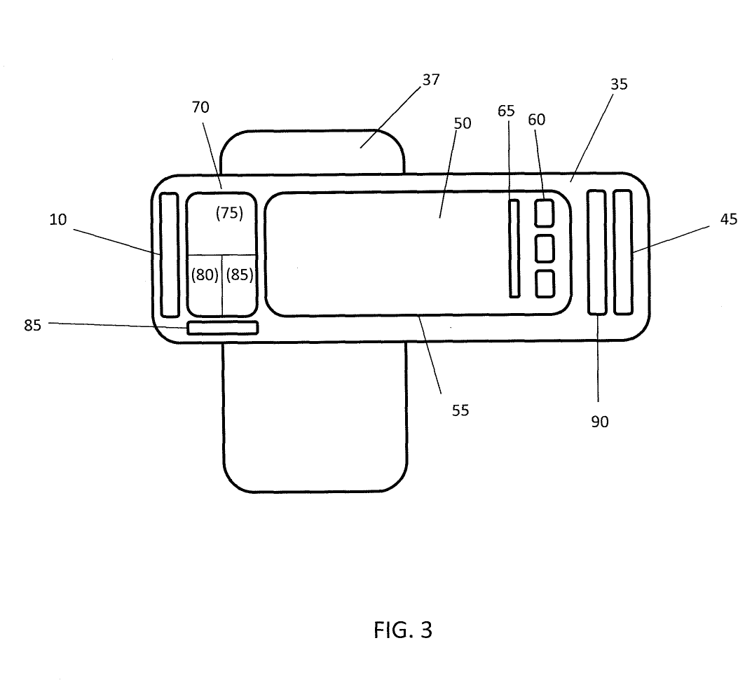

As shown in FIG. 3, the ambulatory patient device 35 can likewise include a graphical user interface 55 having a display 50, one or more inputs 60 and alarm/indicators 65. The ambulatory patient device 35 can likewise include a control system 70 that can include at least one processor 75, at least one memory 80 coupled to the at least one processor 75 and including at least one program stored thereon, a power storage cell 85, and a communication module 90.

The ambulatory patient device 35 can be used to sense a variety of physiologic parameters including ECG, QRS, heart rate, ST, arrhythmia, PVC/min, diagnostic ECG, respiration rate, SpO₂, NIBP, IBP, CO₂, temperature, and others. In some implementations, the ambulatory patient device 35 can be a hand-held device used to spot-check one or more physiologic parameters that may not be actively monitored by the patient-assigned monitor 25. In some implementations, the ambulatory patient device 35 is configured to sense any physiologic parameter of a patient that is not already being monitored by the patient-assigned monitor 25. For example, the patient-assigned monitor 25 can be an ECG device and the ambulatory patient device 35 can be any device other than an ECG device. The ambulatory patient device 35 can incorporate the data acquisition device 10 such that the device 10 is embedded within the ambulatory patient device 35. For example, the ambulatory patient device 35 can be configured to obtain a non-invasive blood pressure measurement and can be coupled to a blood pressure cuff via a port or other coupling location on the ambulatory patient device 35.

In some implementations, the ambulatory patient device 35 can be a portable patient monitor such as the Infinity® M540 portable patient monitor (Dräger Medical GmbH), which can continuously capture and display patient data at the bedside as well as on transport. In some implementations, the ambulatory patient device 35 can be configured to dock with a hardwired docking station 37 located at a patient's bedside and configured to collect data from one or more data acquisition devices 10 acquiring clinical data from a patient 15. It should be appreciated that the ambulatory patient device can also include a cell phone, PDA, iPod touch, iPhone or other smartphone, iPad or other tablet device, or any other device that has an appropriate identification code reader 45. Although the ambulatory patient device 35 is generally a portable, hand-held device it should be appreciated that in some implementations can be a stationary or fixed to a particular location.

The ambulatory patient device 35 can include an identification code reader 45 configured to capture, scan or otherwise read the identification codes 20, 30. In some implementations, the identification code reader 45 is a camera module such as a complementary metal oxide semiconductor (CMOS) image sensor. The ambulatory patient device 35 can include software capable of translating the identification code 20, into information usable by the ambulatory patient device 35. In some embodiments, the identification code reader 45 can include a charge coupled device (CCD) can be used to read codes that are presented as an image on the display of the patient monitor. That is, code readers including a CCD can be used to convert a code presented as an image on the display of the patient monitor into electrical signals which represent the information contained within the code. It should be appreciated that the patient-assigned monitor 25 can also include an identification code reader 45 such that it can be used to read the identification code 20 of a patient 15 or the identification code of another device. For example, the ambulatory patient monitor 35 can have an identification code capable of being captured by the identification code reader of the patient-assigned monitor 25.

The communication module 90 of the ambulatory patient device 35 can be configured to communicate information over a wireless network to an intended location, as will be described in more detail below. The ambulatory patient device 35 can transmit information locally. For example, the ambulatory patient device 35 can transmit information to the patient-assigned monitor 25 such as over a personal area network using short wavelength radio transmissions using Bluetooth technology. In other implementations, the ambulatory patient device 35 can transmit information to the central patient monitor 9, such as via WLAN. It should be appreciated that the ambulatory patient device 35 can also communicate information using a wired connection.

Identification Codes

The patient identification code 20 and the monitor identification code 30 can each be a QR or “quick response” code, which is a two-dimensional matrix of lines and pixels generally oriented in a square shape. QR codes can encode a relatively large capacity of information made of up any kind of data (e.g. binary, alphanumeric, etc.) The amount of data stored can depend on the character set, version and error correction level. The QR codes can be quickly and reliably scanned and read by the identification code reader 45 embedded in a device having QR reader software.

Scanning an identification code 20, 30 using the ambulatory patient device 35 can result in the information embedded in that code getting linked to the clinical data acquired by the ambulatory patient device 35 generating tagged clinical data. The information to which the clinical data is tagged varies according to what identification code 20, 30 is scanned and what information is embedded in the identification code 20, 30. Scanning the patient identification code 20 using an identification code reader 45 can provide information including, but not limited to, encrypted patient-specific information, for example, information used to admit the patient 15, a unit number or a bed number within a hospital or other healthcare-providing system. Reading the monitor identification code 30 using an identification code reader 45 can provide information including, but not limited to, clinical data being acquired from the patient 15 by the one or more data acquisition devices 10, an Internet protocol (IP) address assigned to the patient-assigned monitor, MAC address, etc.

The monitor identification code 30 can be located on the exterior of the patient-assigned monitor 25 in any location that is readily accessible to the caregiver capturing the identification code using the identification code reader 45. In some implementations, the monitor identification code 30 can be presented on an element that is coupled to the patient-assigned monitor 25 (e.g., a sticker that is adhered to the exterior of the patient-assigned monitor 25). In other implementations, the monitor identification code 30 can be integrally formed with a portion of the patient-assigned monitor 25. In still other implementations, the monitor identification code 30 (as well as the patient identification code 20) can be presented on the display 50 of the patient-assigned monitor 25.

The patient identification code 20 can be positioned on the patient 15 in an unobtrusive location so that it will not cause discomfort or harm to the patient 15. The patient identification code 20 can also be positioned in a location to which it is easily applied (e.g., the patient's wrist or ankle). The patient identification code 20 can be physically located on a variety of devices including, without limitation, a bracelet or an ankle strap that cannot be easily removed. The patient identification code 20 can be attached to the patient 15 upon being admitted to the healthcare-providing system so that the patient can be associated with his/her patient identification code 20 throughout the healthcare-providing process.

Wireless Pairing

Many monitoring devices operate on a shared media (i.e. wireless) introducing the problem of uncertainty regarding from which device the data is being collected, such as the intended patient's device or another wireless device in the vicinity of the patient. Previously, to eliminate this uncertainty the devices between which data sharing was desired required a cable connection. The patient monitoring systems described herein allow for the wireless pairing of two devices and tagging of the patient-specific data prior to transmission to ensure that the data transmitted is to an identifiable and intended location, such as a patient record or set of records. The pairing process can be automatically initiated by scanning the identification codes 20, 30 using the ambulatory patient device 35. The pairing process can allow a first device to uniquely pair with one of many other wireless devices such that the data acquired by the first device only gets merged with the data from the intended other device and not other unintended devices in the vicinity. The pairing process can also allow for the communication of patient-specific information from a first device, such as the patient-assigned monitor 25 to which the patient is “known,” to a newly introduced device, such as the ambulatory patient monitor 35 to which the patient is not “known,” such that the clinical data acquired by the newly introduced device is tagged with the patient-specific information. It should be appreciated that the pairing process can be similar to that which occurs in Bluetooth, but that non-Bluetooth pairing processes are considered herein as well.

In some implementations, the patient monitoring systems described herein are useful in a hospital ward in which multiple patients are being continuously monitored for a variety of physiological parameters using wireless monitors. For example, the systems described herein can be used in a telemetry ward. A telemetry ward is typically for patients who may require continued monitoring, such as heart monitoring for patients recovering from heart events or patients who may be at risk of heart events, or experiencing ongoing heart problems. The telemetry ward generally provides for continuous heart rhythm monitoring where the data is collected in one location and transmitted to another. In the case of cardiac telemetry, a patient can wear or otherwise be coupled to one or more data acquisition devices such as electrodes attached to leads and a telemetry transmitter, which can send signals to a patient-assigned monitor and/or a central patient monitoring center, such as a nurses' station, so that the patient can be continuously and unobtrusively monitored by care providers.

The ambulatory patient device 35 described herein can be used by care providers for spot-checking patients for a physiological parameter beyond what is being continuously monitored by the patient-assigned monitor 25. For example, the ambulatory patient device 35 can be used to measure NIBP of a patient being monitored by an ECG patient-assigned monitor. The identification code reader 45 of the ambulatory patient device 35 can be used to read the identification code 30 of the patient-assigned monitor 25 and wirelessly pair the ambulatory patient device 35 to the patient-assigned monitor 25. This also indirectly pairs the ambulatory patient device 35 with the patient 15 as the patient-assigned monitor 25 already “knows” from which patient its clinical data is being collected. It should be appreciated that the patient-specific information can also be obtained using the ambulatory patient device 35 to read the patient identification code 20 on the patient 15 directly. The patient-assigned monitor 25 can also be used to read the patient identification 20 on the patient 15 such that the patient identification data is available from the data stream of the patient-assigned monitor 25.

Upon pairing, the patient-assigned monitor 25 informs the ambulatory patient device 35 from which patient 15 the patient-assigned monitor 25 is collecting clinical data. Further, the patient-assigned monitor 25 can cause any clinical data acquired by the ambulatory patient device 35 upon pairing to be tagged with patient-specific information. The ambulatory patient device 35 can transmit over a wireless network the tagged clinical data to an intended location. In some implementations, the tagged clinical data from the ambulatory patient device 35 can be transmitted locally to the patient-assigned monitor 25. There, the tagged clinical data from the ambulatory patient device 35 can be merged with the data stream from the data acquisition device(s) 10 communicating with the patient-assigned monitor 25 and stored in the patient record in the patient-assigned monitor 25. The patient-assigned monitor 25, in turn, can transmit the merged data streams to the central patient monitor 9. In other implementations, the tagged clinical data from the ambulatory patient device 35 can be transmitted to the central patient monitor 9. There, the tagged clinical data from the ambulatory patient device 35 can be merged with the data stream from the patient-assigned monitor 25 and stored in the patient's medical record on the central patient monitor 9. In some implementations, the patient-assigned monitor 25 and the ambulatory patient device 35 communicate using short wavelength radio transmissions, such as with Bluetooth technology, creating a personal area network. In some implementations, the patient-assigned monitor 25 and the ambulatory patient device 35 each communicate with the central patient monitor 9, such as via WLAN.

Wireless pairing between the patient-assigned monitor 25 and the ambulatory patient device 35 can be automatically initiated upon reading the identification code 30 of the patient-assigned monitor 25 with the identification code reader 45 of the ambulatory patient device 35. The pairing of the ambulatory patient device 35 with the patient-assigned monitor 25 and/or patient 15 initiated by the reading of the identification codes 20, 30 provides for automated pairing and confirmation such that no user interaction is required. The identification code-initiated pairing between the ambulatory patient device 35 and the patient-assigned monitor 25 as well as the tagging of the clinical data with patient-specific information eliminates any ambiguity and uncertainty regarding from where the clinical data originated and to where the data is transmitted.

The patient-assigned monitor 25 and the ambulatory patient device 35 can transmit data to each other via a wireless pairing operation using for example a point-to-point wireless technology such as Bluetooth. It should be appreciated that the communication channel and protocol can vary and any wireless method can be incorporated including proprietary or “standards based” technologies. In some implementations, automated wireless pairing includes the confirmation of matching information embedded in the identification code 30 prior to transmission of the clinical data by the ambulatory patient device 35. In one implementation, the data transmitted by the patient-assigned monitor 25 can include its monitor identification code 30. The monitor identification code 30 transmitted by the patient-assigned monitor 25 can be received by the ambulatory patient device 35. The ambulatory patient device 35 can compare the identification code 30 read by the identification code reader 45 with the identification code 30 received. If they match, then the ambulatory patient device 35 can pair with the patient-assigned monitor 35.

In other implementations, the ambulatory patient device 35 can capture the image of the identification code 30 of the patient-assigned monitor 25 using the image sensor of the identification code reader 45. The information embedded in the identification code 30 is translated by the ambulatory patient device 35. It should be appreciated that the image of the identification code 30 need not be translated prior to identity confirmation. The ambulatory patient device 35 can confirm the information of the captured image matches the corresponding information stored by the patient-assigned monitor 25. If the information matches, the ambulatory patient device 35 and the patient-assigned monitor 25 are paired and clinical data from the ambulatory patient device 35 is tagged and transmitted to the patient-assigned monitor 25. Alternatively, if the intended location for the transmission of acquired clinical data from the ambulatory patient device 35 is a central patient monitor 9, a similar confirmation process can be performed by the ambulatory patient device 35 prior to transmission of the clinical data to the patient record on the central patient monitor 9.

In some implementations, the pairing can operate according to a setting that further enhances safety, such as an additional prompt that requires some user interaction for confirmation. For example, the prompt for confirmation on the ambulatory patient device 35 can be displayed for the clinician to review and verify the pairing prior to the transmission of patient clinical data from the ambulatory patient device 35. The clinician (or any other user of the ambulatory patient device 35) can be required to confirm the proposed pairing is correct and activate a confirmation command (e.g. activation of an input 60 on the ambulatory patient device 35).

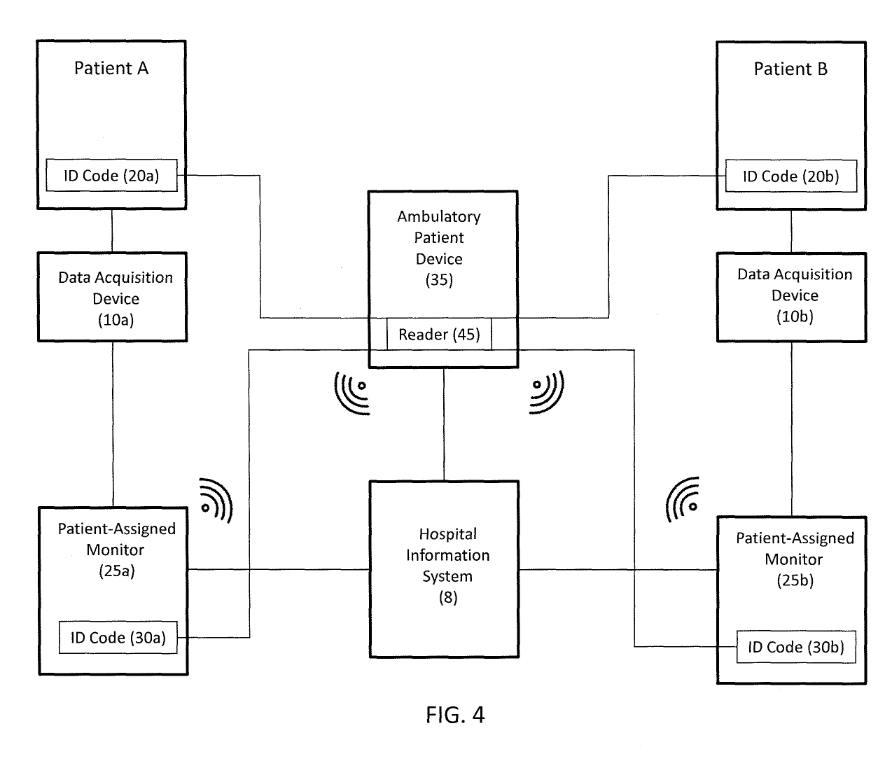

As shown in FIG. 4, a clinician carrying an ambulatory patient device 35 can enter a ward or a patient room containing, for example, Patient A and Patient B to obtain a NIBP measurement from each patient. The clinician can use the identification code reader 45 of the ambulatory patient device 35 to capture the monitor identification code 30a on the patient-assigned monitor 25a of Patient A to initiate pairing such that the identity of Patient A is known to both the corresponding patient-assigned monitor 25a recording data from Patient A data acquisition device 10a and the ambulatory patient device 35. The patient-assigned monitor 25a and the ambulatory patient device 35 can pair such that their respective communication modules 90 are in two-way communication with one another. The clinician can then use the ambulatory patient device 35 to perform additional clinical data acquisition from Patient A, such as taking a NIBP measurement of Patient A. The clinical data acquired by the ambulatory patient device 35 can be tagged with Patient A-specific information and communicated to the patient-assigned monitor 25a to be incorporated into Patient A medical record. Alternatively, the ambulatory patient device 35 can transmit the tagged clinical data to a central patient monitor (not shown) such that the clinical data is merged with the medical record for Patient A stored on the central patient monitor.

The clinician can then release the pairing between the ambulatory patient device 35 and the patient-assigned monitor 25a such as by pressing an input or such as an “un-pair” button or other mechanism on the ambulatory patient device 35 to release the pairing of the two devices. If the clinician fails to release the pairing of the Patient A patient-assigned monitor 25a with the ambulatory patient device 35, then the ambulatory patient device 35 can be prevented from pairing with another device. In some implementations, the clinician need not perform an un-pairing operation on the ambulatory patient device 35. Instead, un-pairing can occur upon initiation of a new pairing with another device or monitor. In another implementation, un-pairing between two devices can occur based on monitoring of the respective received signal strength indicator (RSSI). If the RSSI value falls outside of a range or threshold limit, the two devices become un-paired. A significant enough change in measured RSSI can occur whenever one of the two devices is moved to a new location. Examples of pairing and un-pairing between two medical devices based on detected proximity are described in U.S. Pat. No. 8,001,235, which is incorporated by reference herein in its entirety.

Still with respect to FIG. 4, the clinician can attend to Patient B to obtain a NIBP measurement using the same ambulatory patient device 35. Patient B may be in the vicinity of Patient A, such as in the same room or ward. The clinician can use the identification code reader 45 of the ambulatory patient device 35 to capture the monitor identification code 30b on the patient-assigned monitor 25b of Patient B to initiate pairing such that the identity of Patient B is known to both the corresponding patient-assigned monitor 25b recording data from Patient B data acquisition device 10b and the ambulatory patient device 35. The patient-assigned monitor 25b and the ambulatory patient device 35 can then pair such that their respective communication modules 90 are in two-way communication with one another. The clinician can then use the ambulatory patient device 35 to perform data acquisition from Patient B, such as taking a NIBP or measurement of Patient B. The clinical data acquired by the ambulatory patient device 35 can be tagged with Patient B-specific information and communicated to the patient-assigned monitor 25b to be incorporated into Patient B medical record. Alternatively, the ambulatory patient device 35 can transmit the tagged clinical data to a central patient monitor such that the clinical data is merged with the medical record for Patient B stored on the central patient monitor. The identification code-initiated pairing of the ambulatory patient device 35 with the patient assigned monitor 25b eliminates the uncertainty as to whether the data acquired and transmitted has affected the medical record of Patient B.

Various aspects of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, the memory, at least one input device, and at least one output device such as a display.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The implementations set forth in the foregoing description do not represent all implementations consistent with the subject matter described herein. Instead, they are merely some examples consistent with aspects related to the described subject matter. Wherever possible, the same reference numbers will be used throughout the drawings to refer to the same or like parts.

Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows and steps for use described herein do not require the particular order shown, or sequential order, to achieve desirable results. Other embodiments can be within the scope of the claims.

1.-35. (canceled)

36. A system comprising:
a first data acquisition device configured to be coupled to the patient to acquire clinical data;
a patient-assigned monitor coupled to the first data acquisition device, wherein the patient-assigned monitor comprises a first wireless communication module and a monitor identification code; and
a patient device comprising an identification code reader configured to capture the monitor identification code, a second data acquisition device configured to acquire clinical data from the patient and a second wireless communication module,
wherein capture of the monitor identification code by the identification code reader automatically initiates wireless pairing between the patient-assigned monitor and the patient device.

37. A system as in claim 36, wherein the clinical data acquired from the second data acquisition device is tagged with patient-specific information by the patient-assigned monitor.

38. A system as in claim 37, wherein the patient-specific information comprises one or more of a patient hospital identification number, patient name, patient date of birth, patient bed number, and patient room.

39. A system as in claim 36, wherein the clinical data acquired from the second data acquisition device is wirelessly transmitted from the patient device to the patient-assigned monitor.

40. A system as in claim 39, wherein the wirelessly transmitted clinical data is merged with a medical record for the patient stored in the patient-assigned monitor.

41. A system as in claim 36, wherein the clinical data acquired from the second data acquisition device is wirelessly transmitted from the patient device to a central patient monitor.

42. A system as in claim 41, wherein the wirelessly transmitted clinical data is merged with a medical record for the patient stored in the central patient monitor.

43. A system as in claim 36 further comprising a patient identification code configured to be coupled to a patient.

44. A system as in claim 43, wherein at least one of the patient identification code and the monitor identification code comprises a quick response (QR) code.

45. A system as in claim 43, wherein at least one of the patient identification code and the monitor identification code comprises encoded patient-specific information.

46. A system as in claim 43, wherein the patient-assigned monitor further comprises an identification code reader configured to capture the patient identification code.

47. A system as in claim 36, wherein the monitor identification code is positioned on an exterior portion of the patient-assigned monitor.

48. A system as in claim 36, wherein the patient-assigned monitor further comprises a graphical user interface and the monitor identification code is displayed on the graphical user interface.

49. A system as in claim 36, wherein the identification code reader comprises a CMOS image sensor or CCD image sensor.

50. A system as in claim 36, wherein the first data acquisition device comprises at least one of a heart rate monitor, a pulse oximetry sensor, a sphygmomanometer, a thermometer, and electrocardiology equipment.

51. A system as in claim 50, wherein the second data acquisition device comprises at least one of a heart rate monitor, a pulse oximetry sensor, a sphygmomanometer, a thermometer, and electrocardiology equipment.

52. A system as in claim 51, wherein the second data acquisition device is different from the first data acquisition device.

53. A system as in claim 36, wherein each of the wireless communication modules comprises a BLUETOOTH communication device.

54. A system as in claim 36, wherein the patient device is an ambulatory patient device.

55. A method comprising:
acquiring clinical data using a first data acquisition device coupled to a patient and communicating the clinical data to a patient-assigned monitor, wherein the patient-assigned monitor comprises a monitor identification code and a wireless communication module;
reading the monitor identification code with an identification code reader of an ambulatory patient device, wherein the ambulatory patient device comprises a wireless communication module and a second data acquisition device;
automatically initiating wireless pairing between the wireless communication module of the patient-assigned monitor with the wireless communication module of the ambulatory patient device;
acquiring clinical data from the patient using the second data acquisition device of the ambulatory patient device; and
wirelessly transmitting the clinical data acquired from the patient using the second data acquisition device.

56. An apparatus comprising:
means for acquiring clinical data using a first data acquisition device coupled to a patient and communicating the clinical data to a patient-assigned monitor, wherein the patient-assigned monitor comprises a monitor identification code and a wireless communication module;
means for reading the monitor identification code with an identification code reader of an ambulatory patient device, wherein the ambulatory patient device comprises a wireless communication module and a second data acquisition device;
means for automatically initiating wireless pairing between the wireless communication module of the patient-assigned monitor with the wireless communication module of the ambulatory patient device;
means for acquiring clinical data from the patient using the second data acquisition device of the ambulatory patient device; and
means for wirelessly transmitting the clinical data acquired from the patient using the second data acquisition device.
